(19) United States
(12) Patent Application Publication
(10) Pub. No.: US 2012/0263555 A1
(43) Pub. Date: Oct. 18, 2012

(54) MODULAR QUICK ASSEMBLING APPARATUS

(76) Inventor: TING-JUI WANG, New Taipei City (TW)

(21) Appl. No.: 13/343,945

(22) Filed: Jan. 5, 2012

(30) Foreign Application Priority Data
Apr. 12, 2011 (TW) 100112632

(51) Int. Cl. F16B 23/00

(52) U.S. Cl. 411/337

(57) ABSTRACT

A modular quick assembling apparatus includes a plastic cap, a ferrule and a locking element; the plastic cap has a first penetrating hole, and a first anti-rotating portion, a support portion and a snap portion formed on a sidewall of the first penetrating hole; the ferrule is passed into the first penetrating hole of the plastic cap; the locking element has a head portion and a locking portion coupled to the head portion, and the head portion has a second anti-rotating portion corresponding to the first anti-rotating portion, so that the components can be assembled securely with each other, and the plastic cap, ferrule and locking element can be manufactured separately by an automated machine or manually without adopting the conventional insert molding technique, so as to achieve the effects of facilitating the manufacture, improving the production capacity and lowering the cost.

### CROSS-REFERENCE TO RELATED APPLICATION

This non-provisional application claims priority under 35 U.S.C. §119(a) on Patent Application No(s). 100112632 filed in Taiwan, R.O.C. on Apr. 12, 2011, the entire contents of which are hereby incorporated by reference.

### FIELD OF THE INVENTION

The present invention relates to a modular quick assembling apparatus, in particular to an improved structure of a modular quick assembling apparatus for assembling two objects.

### BACKGROUND OF THE INVENTION

With reference to FIGS. 1 and 2 for a conventional locking element, the locking element comprises a screw 10, a cap 20 and a ferrule 30; wherein the screw 10 has a stress portion 101 formed at an end, and a threading rod 10 formed at the other end and coupled to the stress portion 101; the cap 20 is sheathed on a hollow cylinder of the stress portion 101 of the screw 10 for covering and protecting the screw 10; and the ferrule 30 is sheathed on an end of the cap 20 and has an assembling portion 301 formed at an end of the ferrule 30. Therefore, the assembling portion 301 of the ferrule 30 can be assembled and combined into a hole of a first object, and then the threading rod 102 of the screw 10 can be corresponsive to a screw hole of a second object, and a tool is used to apply an external rotating force to the stress portion 101 of the screw 10, so that the threading rod 102 can pass through the hole of the first object to secure the screw hole of the second object to complete an assembly that connects the two objects.

Wherein, the cap 20 is formed by plastic injection molding, and an insert molding technique is generally used in a conventional manufacturing process. The manufactured screw 10 is placed into an injection molding mold, and then the cap 20 formed by injection molding is covered onto the stress portion 101 of the screw 10 to achieve the effect of fixing and combining the screw 10 with the cap 20. To prevent the screw 10 and the cap 20 from rotating with respect to each other (or being loosened), an anti-slippery pattern 103 is punched and formed at the stress portion 101 of the screw 10, so that the anti-slippery pattern 103 can provide an interference effect to the cap 20 to prevent the screw 10 and the cap 20 from rotating with respect to each other.

However, the assembling of the screw 10 and the cap 20 by the insert molding technique has the following drawbacks:

(1) The manufacture requires a tedious manufacturing procedure and manpower to place the screws 10 one by one into the injection molding mold manually before the injection molding process takes place, and the manufacturing procedure is relatively cumbersome and troublesome.

(2) A high-precision or secondary manufacture of the screw is required, thus incurring a higher manufacturing cost. Since the manufacturing procedure is cumbersome and inapplicable for mass production, the manufacturing cost becomes relatively high.

(3) The screw 10 may be loosened easily. Since the screw 10 only uses the anti-slippery pattern 103 to provide the interference effect to the cap 20, loosened screws occur frequently due to the insufficient interference and stability, so that the cap 20 fails to drive the screw 10 when the cap 20 is turned.

### SUMMARY OF THE INVENTION

In view of the aforementioned shortcomings of the prior art, the inventor of the present invention based on years of experience in the related industry to conduct extensive researches and experiments, and finally developed a modular quick assembling apparatus, in hope of achieving the effects of providing a secured structure, facilitating the manufacture, improving the production capacity and lowering the cost.

It is a primary objective of the present invention to provide an improved structure of a modular quick assembling apparatus comprising a plastic cap, a ferrule and a locking element, wherein the ferrule and the locking element are passed and installed sequentially to the plastic cap to form an assembly without adopting the conventional insert molding technique, so as to achieve the effects of providing a stable structure, facilitating the manufacture, improving the production capacity and lowering the cost.

To achieve the aforementioned and other objectives, the present invention provides a modular quick assembling apparatus comprising: a plastic cap, having a first end, a second end disposed on an opposite side of the first end, and a first penetrating hole interconnected to the first end and the second end, and the first end having a snap portion formed at the first penetrating hole; a ferrule, having a fixed end for assembling to another object, and a second penetrating hole interconnected to the fixed end; and a locking element, having a head portion, and a locking portion coupled to an end of the head portion, and the locking element passing into the first penetrating hole of the plastic cap, such that the locking portion can be extended into the second penetrating hole of the ferrule; wherein, the head portion has a force applying end, a locking end coupled to the locking portion, a sidewall coupled to the force applying end and the locking end, such that the force applying end can be snapped and limited by the snap portion of the plastic cap.

In a preferred embodiment of the present invention, the sidewall of the first penetrating hole of the plastic cap has a support portion, and the locking end of the head portion of the locking element abuts the support portion of the plastic cap.

In a preferred embodiment of the present invention, the ferrule includes a sheathing end sheathed on the second end of the plastic cap, and the second penetrating hole is interconnected to the sheathing end and the fixed end.

In a preferred embodiment of the present invention, the sidewall of the first penetrating hole of the plastic cap has at least one first anti-rotating portion; and the sidewall of the head portion of the locking element has a second anti-rotating portion corresponding to the first anti-rotating portion.

In a preferred embodiment of the present invention, the first anti-rotating portion of the plastic cap and the second anti-rotating portion of the locking element are corresponding planes leaning against each other.

In a preferred embodiment of the present invention, the first end and the snap portion of the plastic cap include at least one notch, so that the snap portion has elasticity for an expansion.

In a preferred embodiment of the present invention, the second end of the plastic cap has a first stop portion for axially interfering the ferrule, and the sheathing end of the ferrule has a second stop portion for axially interfering the first stop portion.

In a preferred embodiment of the present invention, the locking portion of the locking element includes a long rod and a thread formed at the long rod.

In a preferred embodiment of the present invention, the preferred embodiment further comprises an elastic element with an end abutting the locking element, and the other end abutting the ferrule.

In a preferred embodiment of the present invention, the sidewall of the first penetrating hole of the plastic cap has two corresponding first anti-rotating portions, and the sidewall of the locking element has two second anti-rotating portions corresponding to the two first anti-rotating portions respectively.

In a preferred embodiment of the present invention, the sidewall of the first penetrating hole of the plastic cap has three or more first anti-rotating portions, and the sidewall of the locking element has a second anti-rotating portion corresponding to the three or more first anti-rotating portions. Wherein, the first anti-rotating portions are coupled with one another to form a polygon, and the second anti-rotating portions are coupled with one another to form a polygon.

Therefore, the plastic cap, ferrule and the locking element of the modular quick assembling apparatus of the present invention can be manufactured separately first, and then an automated machine or manpower is used to place the ferrule into the first penetrating hole of the plastic cap, and the elastic element and the locking element are placed into the first penetrating hole of the plastic cap, so that as long as a force is applied to the head portion of the locking element, the head portion can be passed through the snap portion of the plastic cap to form the second anti-rotating portion of the locking element corresponding to the first anti-rotating portion of the plastic cap, and the locking end of the head portion abuts the support portion of the plastic cap, and the force applying end of head portion is snapped and limited by the snap portion of the plastic cap, so that the locking element and the plastic cap cannot be rotated with respect to each other, moved axially, or assembled in an opposite direction. In other words, the locking element, elastic element and ferrule are installed sequentially at the second end of the plastic cap, such that the force applying end of the locking element is snapped and limited by the snap portion of the plastic cap, so as to achieve the effects of providing a stable structure, facilitating the manufacture, improving the production capacity and lowering the cost.

### BRIEF DESCRIPTION OF THE DRAWINGS

FIG. 1 is a cross-sectional view of a conventional locking element;

FIG. 2 is a distal view showing an assembling end of a conventional locking element;

FIG. 3 is an exploded view of a first preferred embodiment of the present invention;

FIG. 4 is a cross-sectional view of the first preferred embodiment of the present invention;

FIG. 5 is a distal view of the first preferred embodiment of the present invention;

FIG. 6 is an exploded view of a second preferred embodiment of the present invention;

FIG. 7 is a cross-sectional view of Section A-A of the second preferred embodiment of the present invention;

FIG. 8 is a distal view showing an assembling end of the second preferred embodiment of the present invention;

FIG. 9 is a cross-sectional view of Section B-B of the second preferred embodiment of the present invention; and

FIG. 10 is a cross-sectional view showing an assembling end of a third preferred embodiment of the present invention.

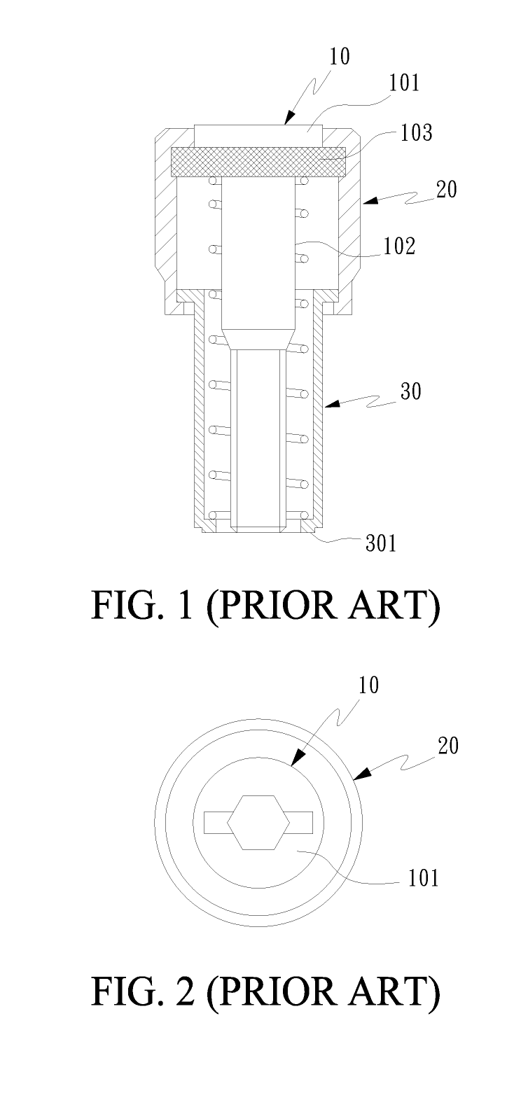

### DETAILED DESCRIPTION OF THE PREFERRED EMBODIMENTS

The objects, characteristics and effects of the present invention will become apparent with the detailed description of the preferred embodiments and the illustration of related drawings as follows.

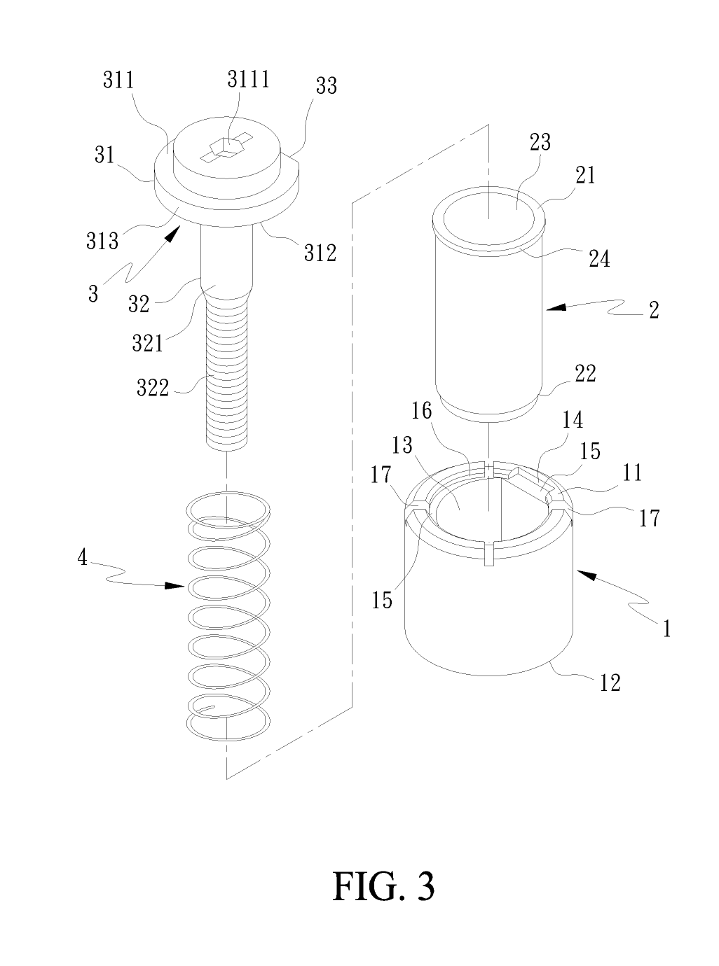

With reference to FIGS. 3 to 5 for a modular quick assembling apparatus in accordance with the first preferred embodiment of the present invention, the modular quick assembling apparatus comprises a plastic cap 1, a ferrule 2 and a locking element 3, wherein the plastic cap 1 is a plastic component produced by an injection molding method in advance, and comprising a first end 11, a second end 12 disposed on the opposite side of the first end 11, and a first penetrating hole 13 interconnected to the first end 11 and the second end 12, wherein the first end 11 has a snap portion 16 protruded from the ferrule 2 in the first penetrating hole 13 for assembling to a fixed end 22 of another object, and a second penetrating hole 23 interconnected to the fixed end 22. The locking element 3 is provided for locking a component of the other object and includes a head portion 31 and a locking portion 32 coupled to an end of the head portion 31, and the locking element 3 is passed into the first penetrating hole 13 of the plastic cap 1, such that the locking portion 32 can be extended to the second penetrating hole 23 of the ferrule 2, wherein the head portion 31 includes a force applying end 311, a force applying slot 3111 formed at the force applying end and provided for a tool to apply forces, a locking end 312 coupled to the locking portion 32, a sidewall 313 coupled to the force applying end 311 and the locking end 312, so that after the locking element 3 is passed through the first end 11 of the plastic cap 1 into the first penetrating hole 13, the force applying end 311 of the head portion 31 is snapped in and limited by the snap portion 16 of the plastic cap 1, and the locking element 3 and the plastic cap 1 cannot be moved axially, so as to constitute the modular quick assembling apparatus of the present invention.

With reference to FIGS. 3 and 5 for the preferred embodiment of the present invention, the plastic cap 1 comprises a support portion 15 formed on a sidewall of the first penetrating hole 13, and the locking end 312 at the head portion 31 of the locking element 3 abuts the support portion 15 of the plastic cap 1 to limit the locking element 3 and the plastic cap 1 from moving axially.

In FIGS. 3 and 5, the ferrule 2 of the preferred embodiment of the present invention comprises a sheathing end 21 sheathed on the second end 12 of the plastic cap 1, and the second penetrating hole 23 is interconnected to the sheathing end 21 and the fixed end 22, such that the ferrule 2 can be axially retracted into the first penetrating hole 13 of the plastic cap 1.

In FIGS. 3 and 5, the plastic cap 1 of the preferred embodiment of the present invention comprises at least one first anti-rotating portion 14 formed on the sidewall of the first penetrating hole 13, and the sidewall 313 of the head portion 31 of the locking element 3 has a second anti-rotating portion 33 corresponding to the first anti-rotating portion 14, so that the locking element 3 and the plastic cap 1 cannot be moved axially or rotated with each respect to each other to achieve the effect of a secured assembly.

In FIGS. 3 and 5, the first anti-rotating portion 14 of the plastic cap 1 and the second anti-rotating portion 33 of the locking element 3 in accordance with the preferred embodiment of the present invention are planes leaning against each other.

In FIGS. 3 to 5, the plastic cap 1 of the preferred embodiment of the present invention comprises at least one notch 17 formed at the first end 11 and the snap portion 16, such that the snap portion 16 has elasticity for an expansion to facilitate passing the head portion 31 of the locking element 3 through the snap portion 16 and assembling the head portion 31 of the locking element 3 into the first penetrating hole 13 of the plastic cap 1.

In FIGS. 3 to 5, the plastic cap 1 of the preferred embodiment of the present invention comprises a first stop portion 18 formed at the second end 12 for axially interfering the ferrule 2, and the sheathing end 21 of the ferrule 2 has a second stop portion 24 for axially interfering the first stop portion 18, such that the ferrule 2 can be axially retracted into the first penetrating hole 13 of the plastic cap 1 only and cannot be separated by the plastic cap 1.

In FIGS. 3 to 5, the locking element 3 of the preferred embodiment of the present invention comprises a locking portion 32 having a long rod 321 and a thread 322 formed on the long rod 321. A user can press the head portion 31 of the locking element 3 to extend the long rod 321 and the thread 322 out from the fixed end 22 of the ferrule 2, so that the thread 322 can be used for locking to another object.

In FIGS. 3 to 5, the preferred embodiment of the present invention further comprises an elastic element 4 sheathed on the locking portion 32 of the locking element 3, so that an end of the elastic element 4 abuts the locking element 3, and the other end abuts the ferrule 2. Therefore, the locking portion 32 of the locking element 3 is retracted into the ferrule 2, when not used. However, the elastic element 4 is not limited to the aforementioned sheathing position and abutting position only, but any equivalent structure that allows the locking portion 32 of the locking element 3 to be retracted into the ferrule 2 can be adopted in the present invention as well.

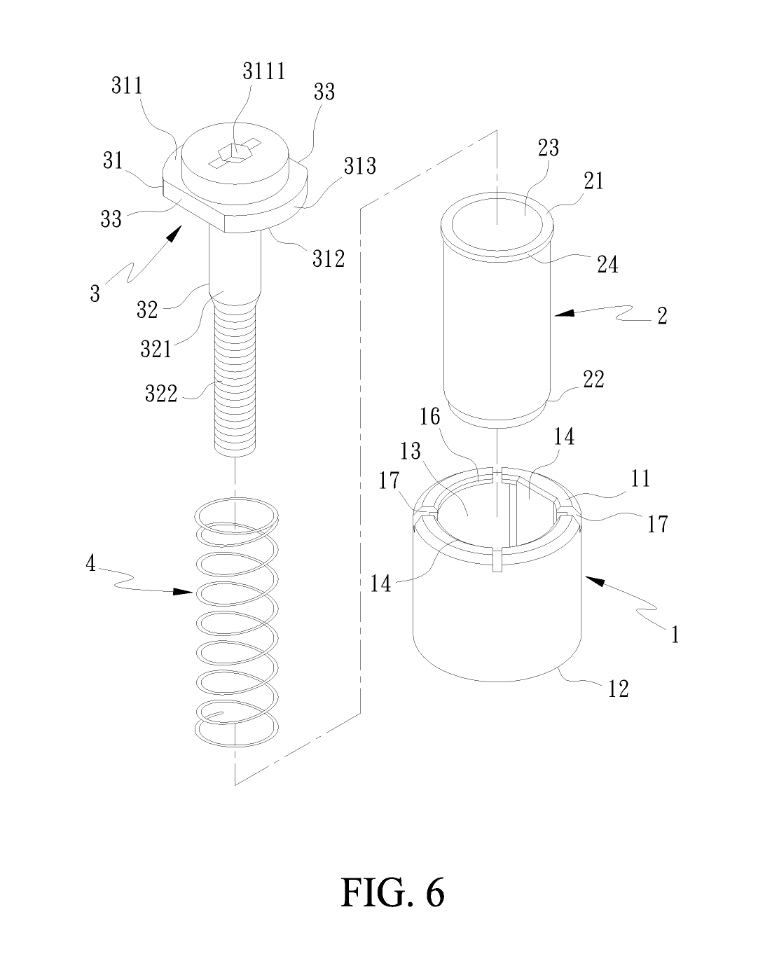

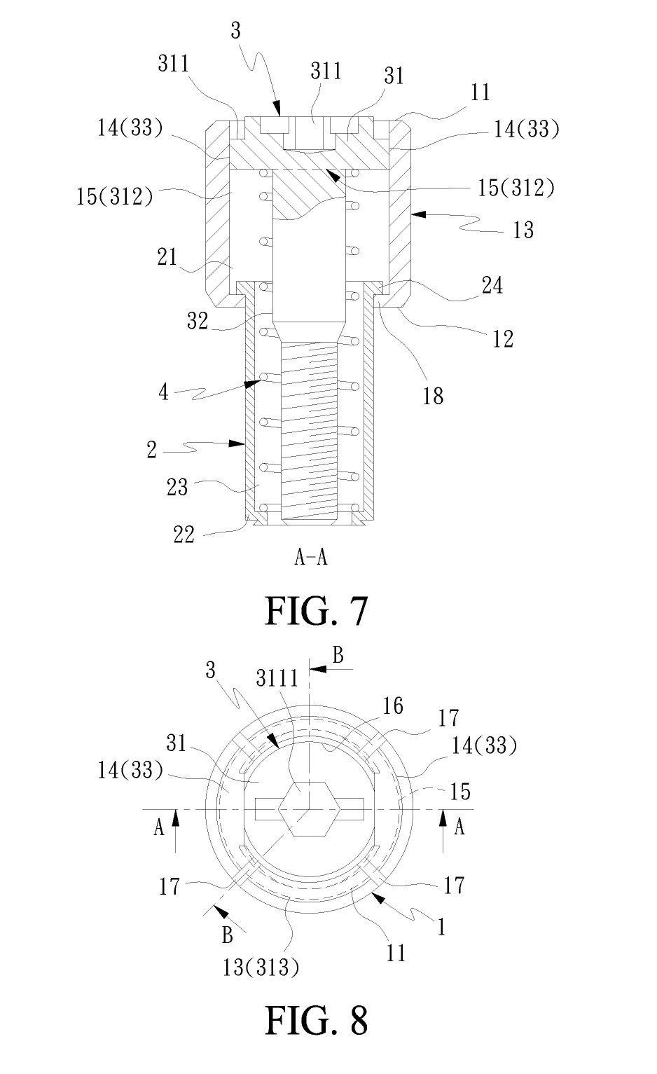

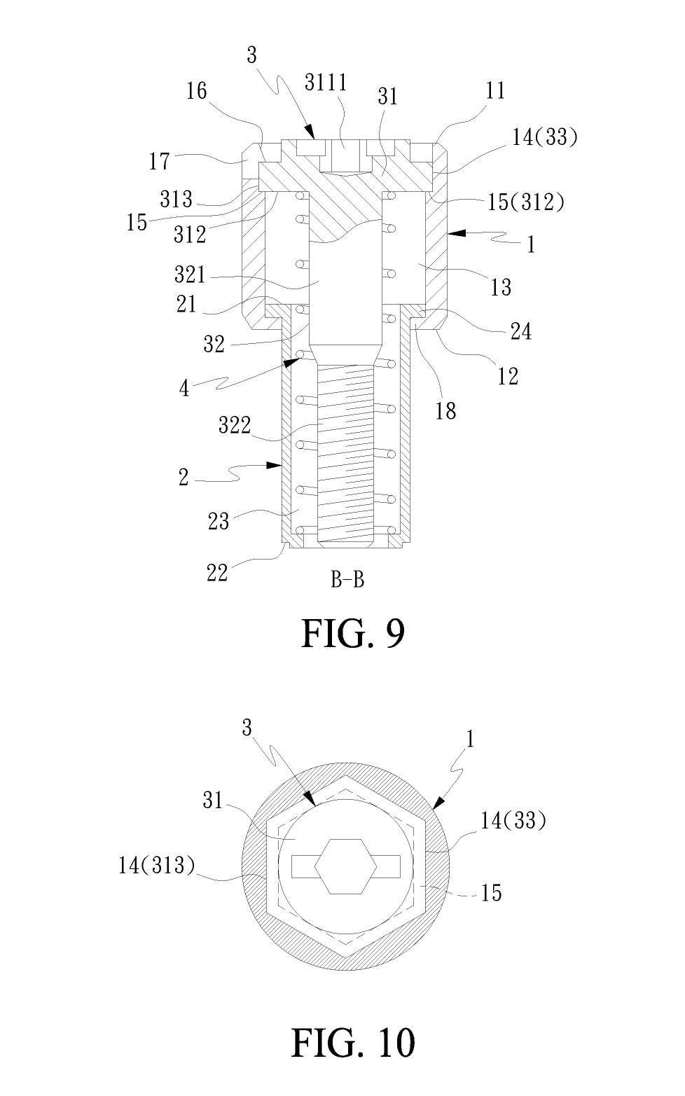

With reference to FIGS. 6 to 9 for a second preferred embodiment of the present invention, the second preferred embodiment further comprises two corresponding first anti-rotating portions 14 formed on the sidewall of the first penetrating hole 13 of the plastic cap 1, and two second anti-rotating portions 33 formed on a sidewall 313 of the head portion 31 of the locking element 3 and corresponding to the two first anti-rotating portions 14 respectively. Similarly, the third preferred embodiment of the present invention as shown in FIG. 10 comprises three or more first anti-rotating portions 14 formed on a sidewall of the first penetrating hole 13 of the plastic cap 1, and a second anti-rotating portion 33 formed on the sidewall 313 of the head portion 31 of the locking element 3 and corresponding to the three or more first anti-rotating portions 14. Wherein, the first anti-rotating portions 14 are coupled with one another to form a polygon, and the second anti-rotating portion 33 are also coupled with one another to form a polygonal head portion 31.

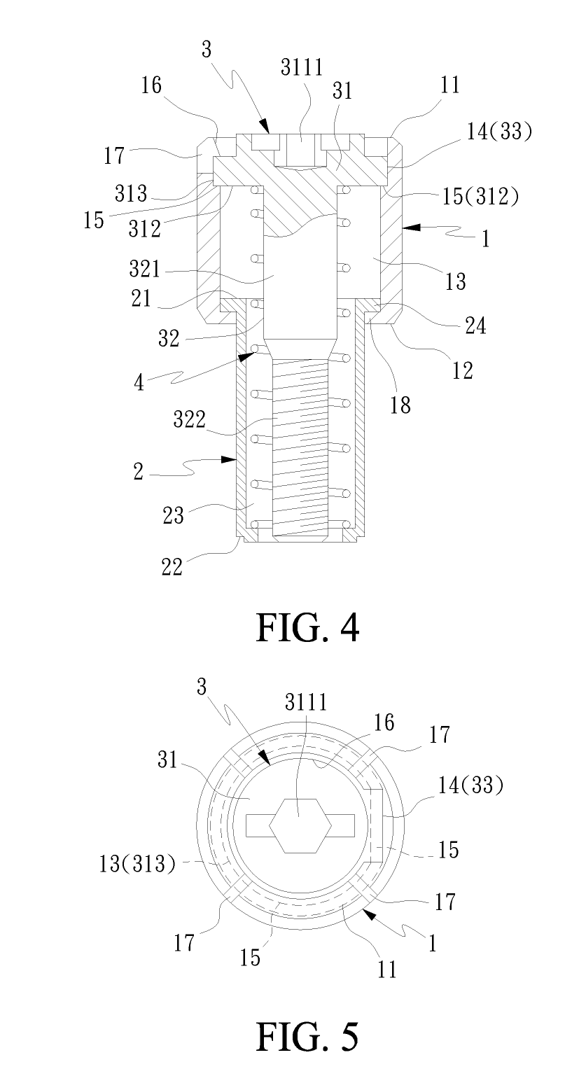

In the foregoing improved structure having the plastic cap 1, ferrule 2 and locking element 3, the plastic cap 1, ferrule 2 and locking element 3 can be manufactured separately without using the conventional insert molding method to avoid the shortcomings of the insert molding technique. In the process of assembling the plastic cap 1, ferrule 2 and locking element 3 to produce the modular quick assembling apparatus of the present invention as shown in FIGS. 3 and 4, an automated machine or manpower is used to place the ferrule 2 into the first penetrating hole 13 of the plastic cap 1 first, such that the first stop portion 18 of the plastic cap 1 axially interferes with the second stop portion 24 of the ferrule 2 to prevent the separation of the two, and then the elastic element 4 is placed into the first penetrating hole 13 of the plastic cap 1, and an end of the elastic element 4 abuts the ferrule 2, and finally the locking element 3 is placed into the first penetrating hole 13 of the plastic cap 1. When the head portion 31 of the locking element 3 reaches the snap portion 16 of the plastic cap 1, a user can simply apply a force at the head portion 31 of the locking element 3 to pass the sidewall 313 of the head portion 31 through the snap portion 16 of the plastic cap 1 to form the second anti-rotating portion 33 of the locking element 3 corresponding to the first anti-rotating portion 14 of the plastic cap 1, and the locking end 312 of the head portion 31 abuts the support portion 15 of the plastic cap 1, and the force applying end 311 of the head portion 31 is snapped and limited by the structure of the snap portion 16 of the plastic cap 1, so that the locking element 3 and the plastic cap 1 cannot be rotated with respect to each other, or moved axially, so as to constitute the modular quick assembling apparatus of the present invention. In addition, the present invention can be assembled in an opposite direction. In other words, the locking element 3, elastic element 4 and ferrule 2 are placed sequentially at the second end 12 of the plastic cap 1, so that the force applying end 311 of the locking element 3 is snapped and limited by the snap portion 16 of the plastic cap 1 to constitute the modular quick assembling apparatus of the present invention.

Since the second anti-rotating portion 33 of the locking element 3 is corresponsive to the first anti-rotating portion 14 of the plastic cap 1, the locking element 3 and the plastic cap 1 cannot be rotated with respect to each other. Compared with the conventional anti-slippery pattern, the present invention can provide a more secured structure, and the plastic cap 1, ferrule 2 and locking element 3 are manufactured separately without adopting the insert molding method, so that the invention can avoid the shortcomings of the insert molding technique, and also can assemble objects by an automated machine or manually, so as to achieve the effects of facilitating the manufacture, improving the production capacity and lowering the cost.

In summation of the description above, the present invention provides an improved structure having a plastic cap, a ferrule and a locking element and sequentially installs the ferrule and the locking element to the plastic cap to produce the assembly without adopting the conventional insert molding method to achieve the effects of providing a secured structure, facilitating the manufacture, improving the production capacity and lowering the cost. Obviously, the present invention complies with the patent application requirements, and products produced according to the present invention can sufficiently satisfy industrial requirements.

While the invention has been described by means of specific embodiments, numerous modifications and variations could be made thereto by those skilled in the art without departing from the scope and spirit of the invention set forth in the claims.

What is claimed is:

1. A modular quick assembling apparatus, comprising:
a plastic cap, having a first end, a second end disposed on an opposite side of the first end, and a first penetrating hole interconnected to the first end and the second end, and the first end having a snap portion formed at the first penetrating hole;
a ferrule, having a fixed end for assembling to another object, and a second penetrating hole interconnected to the fixed end; and
a locking element, having a head portion, and a locking portion coupled to an end of the head portion, and the locking element passing into the first penetrating hole of the plastic cap, such that the locking portion is extended into the second penetrating hole of the ferrule;
wherein, the head portion has a force applying end, a locking end coupled to the locking portion, a sidewall coupled to the force applying end and the locking end, such that the force applying end is snapped and limited by the snap portion of the plastic cap.

2. The modular quick assembling apparatus of claim 1, wherein the sidewall of the first penetrating hole of the plastic cap has a support portion, and the locking end of the head portion of the locking element abuts the support portion of the plastic cap.

3. The modular quick assembling apparatus of claim 1, wherein the ferrule includes a sheathing end sheathed on the second end of the plastic cap, and the second penetrating hole is interconnected to the sheathing end and the fixed end.

4. The modular quick assembling apparatus of claim 1, wherein the sidewall of the first penetrating hole of the plastic cap has at least one first anti-rotating portion; and the sidewall of the head portion of the locking element has a second anti-rotating portion corresponding to the first anti-rotating portion.

5. The modular quick assembling apparatus of claim 4, wherein the first anti-rotating portion of the plastic cap and the second anti-rotating portion of the locking element are corresponding planes leaning against each other.

6. The modular quick assembling apparatus of claim 1, wherein the first end and the snap portion of the plastic cap include at least one notch, so that the snap portion has elasticity for an expansion.

7. The modular quick assembling apparatus of claim 1, wherein the second end of the plastic cap has a first stop portion for axially interfering the ferrule, and the sheathing end of the ferrule has a second stop portion for axially interfering the first stop portion.

8. The modular quick assembling apparatus of claim 1, wherein the locking portion of the locking element includes a long rod and a thread formed at the long rod.

9. The modular quick assembling apparatus of claim 1, further comprising an elastic element with an end abutting the locking element, and the other end abutting the ferrule.

10. The modular quick assembling apparatus of claim 1, wherein the sidewall of the first penetrating hole of the plastic cap has two corresponding first anti-rotating portions, and the sidewall of the locking element has two second anti-rotating portions corresponding to the two first anti-rotating portions respectively.

11. The modular quick assembling apparatus of claim 1, wherein the sidewall of the first penetrating hole of the plastic cap has three or more first anti-rotating portions, and the sidewall of the locking element has a second anti-rotating portion corresponding to the three or more first anti-rotating portions.

12. The modular quick assembling apparatus of claim 11, wherein the first anti-rotating portions are coupled with one another to form a polygon, and the second anti-rotating portions are coupled with one another to form a polygon.
